(19) United States
(12) Patent Application Publication
(10) Pub. No.: US 2026/0056356 A1
(43) Pub. Date: Feb. 26, 2026

(54) OPTICAL SYSTEM INCLUDING PANCAKE LENS, DISPLAY DEVICE USING THE SAME, ELECTRONIC DEVICE COMPRISING DISPLAY DEVICE

(71) Applicant: Samsung Display Co., Ltd., Yongin-si (KR)

(72) Inventors: Cheon Myeong LEE, Yongin-si (KR); Soo Min BAEK, Yongin-si (KR); Yong Kyu KANG, Yongin-si (KR); Ji Won LEE, Yongin-si (KR); Ju Hwa HA, Yongin-si (KR)

(21) Appl. No.: 19/212,636

(22) Filed: May 19, 2025

(30) Foreign Application Priority Data
Aug. 23, 2024 (KR) 10-2024-0113415

(51) Int. Cl. G02B 5/30; G02B 27/01

(52) U.S. Cl. CPC G02B 5/3083; G02B 5/3025; G02B 27/0172

(57) ABSTRACT

According to one or more embodiments of the disclosure, an optical system includes a display part including a display layer including a light-emitting element, a first quarter wave plate (QWP) on the display layer, an absorbing polarizing layer on the first QWP, and a second QWP on the absorbing polarizing layer, a light path converter on the display part, and a pancake lens part on the light path converter, wherein the display part is configured to output first light provided to the light path converter, and wherein the light path converter is configured to receive the first light and is configured to output second light of which a light path is converted based on the first light.

### CROSS-REFERENCE TO RELATED APPLICATION

The present application claims priority to, and benefit of, Korean Patent Application No. 10-2024-0113415, filed on Aug. 23, 2024, in the Korean Intellectual Property Office, the entire disclosure of which is incorporated herein by reference.

### BACKGROUND

### 1. Field

The disclosure relates to an optical system including a pancake lens, a display device using the same, and an electronic device comprising the display device.

### 2. Description of the Related Art

As interest in information display has been increasing recently, research and development on a display device have been continuously conducted. An application field of the display device is further expanding, and the display device may be configured to implement a virtual reality system, an augmented reality system, a mixed reality system, one of a combination thereof, or the like.

### SUMMARY

An aspect of the disclosure provides an optical system including a pancake lens with improved optical performance, a display device using the same, and an electronic device comprising the display device.

An aspect of the disclosure provides an optical system including a pancake lens, a display device using the same, and an electronic device comprising the display device, which may not require an excessive physical specification.

According to one or more embodiments of the disclosure, an optical system may include a display part including a display layer including a light-emitting element, a first quarter wave plate (QWP) on the display layer, an absorbing polarizing layer on the first QWP, and a second QWP on the absorbing polarizing layer, a light path converter on the display part, and a pancake lens part on the light path converter, wherein the display part is configured to output first light provided to the light path converter, and wherein the light path converter is configured to receive the first light and is configured to output second light of which a light path is converted based on the first light.

The first light may include circularly polarized light formed by transmitting linearly polarized light from the display layer through the first QWP, the absorbing polarizing layer, and the second QWP, wherein the pancake lens part is configured to receive the second light, and is configured to output third light of which a light path is converted based on the second light.

The first light may be configured to be applied to the light path converter along a display direction, wherein the display direction is substantially perpendicular to a display surface of the display layer.

The first light may be configured to be applied to the light path converter along a direction substantially parallel to a base line, wherein the second light is configured to be applied to the pancake lens part along a direction forming a first angle with respect to the base line.

The base line may be a virtual line extending along the display direction.

The light path converter may be configured to shift a light path of the first light in a direction from a center portion of the pancake lens part toward an edge portion of the pancake lens part.

The display part may be configured to provide the first light to a first range, wherein the pancake lens part is configured to receive the second light in a second range that is wider than the first range.

The light path converter may include an anisotropic structure.

The light path converter may have a flat plate shape.

The light path converter may include at least one of a geometric phase lens or a Pancharatnam-Berry phase plate.

The light path converter may include a concave lens having a negative focal length.

The light path converter may be configured to provide the second light circularly polarized in a direction different from a direction in which the first light is circularly polarized.

The light path converter may be on the display part, and may be spaced apart from the pancake lens part.

The pancake lens part may include a half mirror layer on the light path converter, a lens QWP on the half mirror layer, and a reflective polarizing layer on the lens QWP, and may be configured to receive the second light, and to output a third light based on the second light.

The pancake lens part may include a body lens part having a convex lens shape, wherein the third light is linearly polarized light, and is configured to be applied to a user's pupil.

The light-emitting element may include an organic light-emitting element (OLED) or an inorganic light-emitting element.

According to one or more embodiments of the disclosure, a display device includes an optical system including a display part comprising a display layer comprising a light-emitting element, a first quarter wave plate (QWP) on the display layer, an absorbing polarizing layer on the first QWP, and a second QWP on the absorbing polarizing layer, a light path converter on the display part, and a pancake lens part on the light path converter, wherein the display part is configured to output first light provided to the light path converter, and wherein the light path converter is configured to receive the first light and is configured to output second light of which a light path is converted based on the first light.

The display device may include one of a virtual reality system, an augmented reality system, a mixed reality system, or a combination thereof.

According to one or more embodiments of the disclosure, an optical system including a pancake lens with improved optical performance and a display device using the same may be provided.

According to one or more embodiments of the disclosure, an optical system including a pancake lens, a display device using the same, and an electronic device including the display device, which may not require an excessive physical specification may be provided.

According to one or more embodiments of the disclosure, an electronic device, may include a processor configured to provide input image data, a display device configured to display an image based on the input image data, the display device including sub-pixel areas, and a power supply configured to supply power to the display device, wherein the display device includes an optical system including a display part including a display layer including a light-emitting element, a first quarter wave plate (QWP) on the display layer, an absorbing polarizing layer on the first QWP, and a second QWP on the absorbing polarizing layer, a light path converter on the display part, and a pancake lens part on the light path converter, wherein the display part is configured to output first light provided to the light path converter, and wherein the light path converter is configured to receive the first light and is configured to output second light of which a light path is converted based on the first light.

According to one or more embodiments of the disclosure, the optical system has improved optical performance.

### BRIEF DESCRIPTION OF THE DRAWINGS

The above and other aspects of the disclosure will become more apparent by describing in further detail embodiments thereof with reference to the accompanying drawings, in which:

FIG. 1 is a schematic drawing illustrating an optical system according to one or more embodiments;

FIG. 2 is a schematic cross-sectional drawing illustrating a display part according to one or more embodiments;

FIG. 3 is a schematic drawing illustrating an optical system according to one or more embodiments;

FIG. 4 is a schematic drawing illustrating an optical system according to one or more embodiments;

FIG. 5 is a schematic drawing illustrating a display device using an optical system according to one or more embodiments; and

FIG. 6 is a schematic block diagram illustrating an electronic device including a display device in accordance with one or more embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B”may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),”etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The disclosure relates to an optical system including a pancake lens, a display device using the same, and an electronic device comprising the display device. Hereinafter, an optical system including a pancake lens, a display device using the same, and an electronic device comprising the display device are described with reference to the attached drawings.

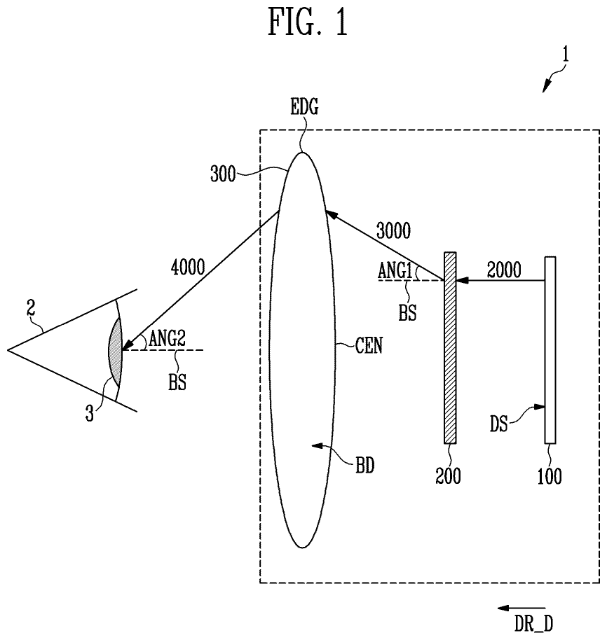

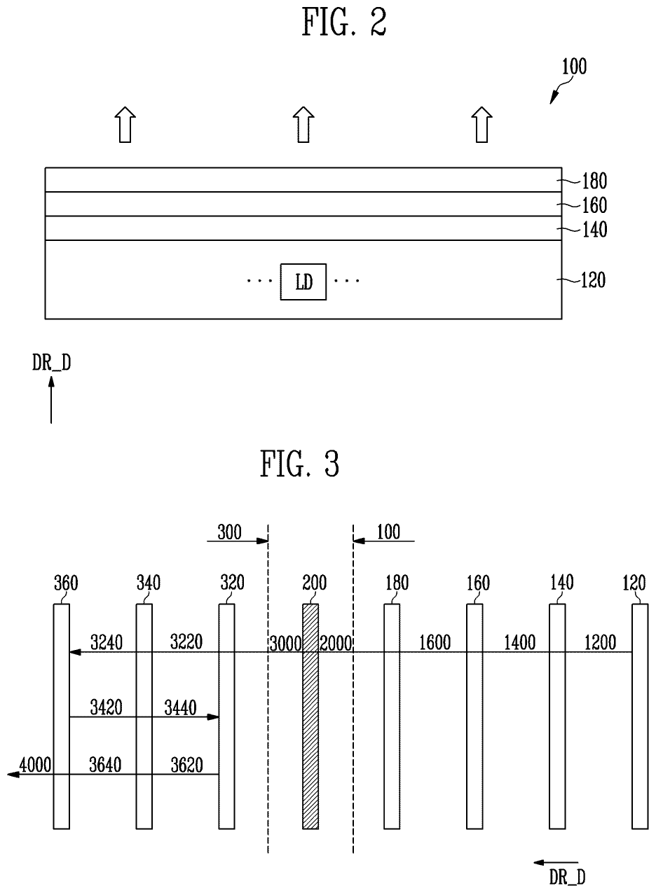

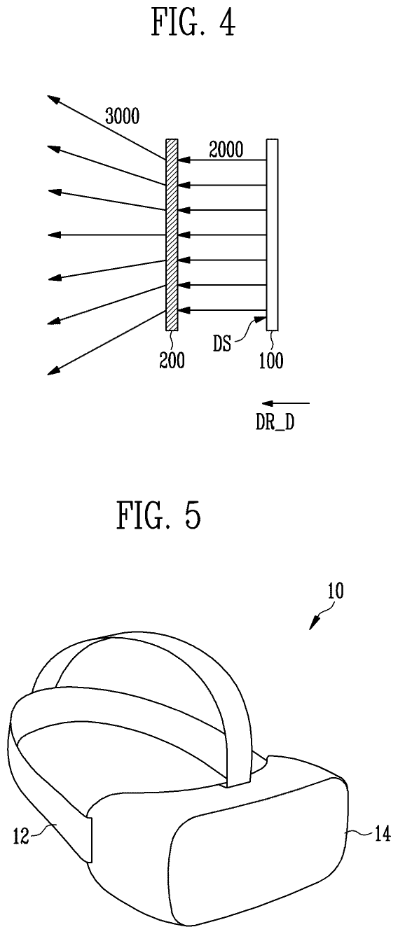

FIG. 1 is a schematic drawing illustrating an optical system according to one or more embodiments. FIG. 2 is a schematic cross-sectional view illustrating a display part according to one or more embodiments. FIG. 3 is a schematic drawing illustrating an optical system according to one or more embodiments. FIG. 4 is a schematic drawing illustrating an optical system according to one or more embodiments. FIG. 5 is a schematic drawing illustrating a display device using an optical system according to one or more embodiments.

Referring to FIGS. 1 to 5, the optical system 1 according to one or more embodiments is configured to provide optical information (for example, an image and the like) to a user 2.

The optical system 1 may include a display part 100, a light path converter 200, and a pancake lens part 300.

In this specification, to more clearly describe lights formed (for example, moved) between components, the lights between the components (for example, lights defined between components) are distinguished and described by ordinal numbers and the like.

First light 2000 may be output from the display part 100 and may be applied to the light path converter 200. The first light 2000 may be light formed (for example, defined) between the display part 100 and the light path converter 200.

Second light 3000 may be output from the light path converter 200 and may be applied to the pancake lens part 300. The second light 3000 may be light formed (for example, defined) between the light path converter 200 and the pancake lens part 300. The second light 3000 may be light based on the first light 2000, and a light path of the second light 3000 may be determined (for example, changed) by the light path converter 200.

Third light 4000 may be output from the pancake lens part 300, and may be applied to a pupil 3 of the user 2. The third light 4000 may be light formed (for example, defined) between the pancake lens part 300 and the pupil 3 of the user 2. The third light 4000 may be light based on the second light 3000, and an optical characteristic and a light path of the third light 4000 may be determined (for example, changed) by the pancake lens part 300.

The display part 100 may provide the first light 2000 along a display direction DR_D, and the first light 2000 may be generally moved along the display direction DR_D and may be provided to the user 2. According to one or more embodiments, the first light 2000 provided by the display part 100 in the optical system 1 may pass through the light path converter 200 and the pancake lens part 300, and may be applied to a portion of the pupil 3 of the user 2 to form an image.

According to one or more embodiments, the display direction DR_D may be a direction perpendicular (for example, substantially perpendicular) to a display surface DS formed by the display part 100. The display surface DS may be formed on one plane and may be a plane on which optical information is output. The display direction DR_D may be a direction perpendicular to a plane where the display part 100 is located. The display direction DR_D may be a thickness direction of a substrate on which a light-emitting element LD of the display part 100 is located.

The display part 100 may output the first light 2000 that is circularly polarized. According to one or more embodiments, the display part 100 may include a display layer 120, a first quarter wave plate (QWP) 140, an absorbing polarizing layer 160, and a second QWP 180.

The display layer 120 may include various light sources. For example, the display layer 120 may include the light-emitting element LD that is a self-emissive element. For example, the light-emitting element LD of the display layer 120 may be an organic light-emitting element (OLED) or an inorganic light-emitting element (for example, a micro light-emitting diode (LED)). However, the disclosure is not limited thereto.

The display layer 120 may provide first internal light 1200. The first internal light 1200 may travel along the display direction DR_D, and may be applied to the first QWP 140. The first internal light 1200 may be unpolarized light.

The first QWP 140 may be located between the display layer 120 and the absorbing polarizing layer 160. The first QWP 140 may receive the first internal light 1200, and may output second internal light 1400 based on the first internal light 1200. Because the first internal light 1200 is unpolarized light, light components of the first internal light 1200 may be circularly polarized by the first QWP 140, and the second internal light 1400 may be unpolarized light including a plurality of circularly polarized components.

The absorbing polarizing layer 160 may be located between the first QWP 140 and the second QWP 180. The absorbing polarizing layer 160 may receive the second internal light 1400, and may output third internal light 1600 based on the second internal light 1400. The second internal light 1400 may be linearly polarized by the absorbing polarizing layer 160, and the third internal light 1600 polarized in one direction (for example, a specific or corresponding direction) may be provided.

The absorbing polarizing layer 160 may include various materials, such as a polymer. However, the disclosure is not limited to any example.

The second QWP 180 may be located on the absorbing polarizing layer 160. The second QWP 180 may receive the third internal light 1600, and may output the first light 2000 based on the third internal light 1600. The third internal light 1600, which is linearly polarized light, may be circularly polarized by the second QWP 180, and thus the first light 2000 that is circularly polarized may be provided.

The first QWP 140 and the second QWP 180 may include various materials. For example, the first QWP 140 and the second QWP 180 may include triacetyl cellulose (TAC), polyvinyl alcohol (PVA), and the like. However, the disclosure is not limited thereto.

Accordingly, the display part 100 may output the first light 2000 that is circularly polarized (for example, right-circularly polarized or left-circularly polarized) in one direction.

The light path converter 200 may be located between the display part 100 and the pancake lens part 300. According to one or more embodiments, the light path converter 200 may be located (for example, directly located) on the display part 100 and may be spaced apart from one surface of the pancake lens part 300.

The light path converter 200 may change a light path of the applied first light 2000 to a direction in which the first light 2000 diverges in an outward direction (refer to FIGS. 1 and 4). For example, the light path converter 200 may induce a light path of at least a portion of the applied first light 2000 to face an outward direction. Light paths (or an aspect of the light path) of the first light 2000 and the second light 3000 will be clearly understood with reference to FIGS. 1 and 4.

For example, the first light 2000 may be applied to the light path converter 200 along a direction that is parallel (for example, generally parallel) to a base line BS, and the second light 3000 of which the light path is changed based on the first light 2000 may form a first angle ANG1 with respect to the base line BS. For example, the second light 3000 may be applied to the pancake lens part 300 along a direction forming the first angle ANG1 with respect to the base line BS.

The base line BS may be a virtual line. The base line BS may extend in a normal direction of a plane where the light path converter 200 is located. The base line BS may extend in a thickness direction of the light path converter 200. The base line BS may extend in a thickness direction of the display part 100. The base line BS may extend in a thickness direction of a substrate of the display part 100. The base line BS may extend (e.g., generally extend) along the display direction DR_D.

The second light 3000 may be applied to the pancake lens part 300 so as to be inclined with respect to the first light 2000. For example, the first light 2000 (for example, the light path of the first light 2000) may be generally parallel to the base line BS, and may face a front surface of the pancake lens part 300. The second light 3000 (for example, the light path of the second light 3000) may be non-parallel to the base line BS and may face an area adjacent to an edge portion EDG of the pancake lens part 300.

For example, the first light 2000 may travel generally parallel to the base line BS, and a path of the first light 2000 may be shifted (for example, changed) in a direction from a center portion CEN of the pancake lens part 300 toward the edge portion EDG of the pancake lens part 300. The path of the first light 2000 may be diverged in a direction from the center portion CEN of the pancake lens part 300 toward the edge portion EDG of the pancake lens part 300.

Accordingly, the first light 2000 that is output from a front surface of the display part 100 and that is provided in a vertical direction (for example, a direction in which the base line BS extends) may be extended to an area adjacent to the edge portion EDG, and may be applied to the pancake lens part 300. That is, the display part 100 may provide the first light 2000 to a first range, and the second light 3000 may be applied to the pancake lens part 300 in a second range that is wider than the first range.

The light path converter 200 may be provided using an anisotropic structure having a size that is similar to a wavelength of applied light. The light path converter 200 may include an anisotropic structure. For example, if circularly polarized light is provided to the anisotropic structure, a phase delay phenomenon for light may occur due to the anisotropic structure.

According to one or more embodiments, the anisotropic structure included in the light path converter 200 may be manufactured using an imprint process, and may also be manufactured using a method of patterning a material of the anisotropic structure and then curing the material (for example, photo-curing or thermal curing).

According to one or more embodiments, the light path converter 200 may include at least one of a geometric phase lens or a Pancharatnam-Berry phase plate.

The geometric phase lens may include a liquid crystal element, a meta element, or the like, and may include a micro-patterned structure. The Pancharatnam-Berry phase plate may include a liquid crystal element, a meta element, or the like, and may include a micro-patterned structure.

The geometric phase lens and the Pancharatnam-Berry phase plate may control a phase delay of applied light. For example, the geometric phase lens and/or the Pancharatnam-Berry phase plate may be configured to operate as a convex lens or a concave lens.

According to one or more embodiments, the light path converter 200 implemented as one of the geometric phase lens or the Pancharatnam-Berry phase plate may operate as a concave lens. For example, the light path converter 200 may have a negative focal length. Accordingly, the light path converter 200 may convert the light path of the first light 2000 to output the second light 3000 that generally faces an area adjacent to the edge portion EDG.

According to one or more embodiments, the light path converter 200 implemented as one of the geometric phase lens or the Pancharatnam-Berry phase plate may be designed to have one refractive power by modulating a phase of incident light differently according to a position.

For example, when light of left-handed circular polarization is incident, the light path converter 200 may modulate a phase to light of right-handed circular polarization. Alternatively, when right-circularly polarized light is incident, the light path converter 200 may modulate a phase to light of left-handed circular polarization.

Accordingly, the second light 3000 may be circularly polarized light. For example, when the first light 2000 is right-handed circularly polarized light, the second light 3000 may be left-handed circularly polarized light. When the first light 2000 is left-handed circularly polarized light, the second light 3000 may be right-handed circularly polarized light.

The light path converter 200 may have a flat plate shape, and may have a desired optical modulation characteristic with a relatively thin thickness. For example, the light path converter 200 may be implemented by patterning materials on a thin substrate. Accordingly, even though the display device 10 is provided using the optical system 1 including the light path converter 200, a physical space may not be excessively used in the display device 10, and the display device 10 having an excellent physical specification, in which a thin thickness characteristic and light weight are achieved, may be provided.

The pancake lens part 300 may be located between the user 2 (for example, the pupil 3 of the user 2) and the light path converter 200 in the optical system 1. For example, one surface of the pancake lens part 300 may be spaced apart to face the light path converter 200, and another surface of the pancake lens part 300 may be spaced apart to face the pupil 3 of the user 2.

The pancake lens part 300 may allow light to move several times between layers forming the pancake lens part 300 to allow the third light 4000 output from the pancake lens part 300 to have a corresponding polarization state.

The pancake lens part 300 may precisely control a polarization state of light using the above-described method, and because the pancake lens part 300 has a relatively thin thickness, the optical system 1 may be more precisely designed. Accordingly, the display device 10 using the optical system 1 may be designed with a more compact design, and in addition, may have high image quality and a relatively excellent viewing angle characteristic.

The pancake lens part 300 may receive the second light 3000, and may output the third light 4000 toward the pupil 3 of the user 2.

The pancake lens part 300 may include a body lens part BD, a half mirror layer 320, a lens QWP 340, and a reflective polarizing layer 360.

According to one or more embodiments, the half mirror layer 320, the lens QWP 340, and the reflective polarizing layer 360 may be located on one surface and/or on another surface of the body lens part BD. For example, the half mirror layer 320, the lens QWP 340, and the reflective polarizing layer 360 may be located (for example, sequentially arranged) on one surface (for example, a surface facing the user 2) of the body lens part BD. However, the disclosure is not limited thereto.

The body lens part BD may have one shape to refract applied light. For example, the body lens part BD may have a convex lens structure, but the disclosure is not limited thereto. For convenience of description, the body lens part BD is omitted in FIG. 3.

According to one or more embodiments, the pancake lens part 300 may change the applied second light 3000 to the third light 4000 having a corresponding polarization characteristic, and may output the third light 4000.

The half mirror layer 320 may be located between the light path converter 200 and the lens QWP 340. The half mirror layer 320 may be configured to reflect a portion of applied light, and may transmit another portion of the applied light.

According to one or more embodiments, the half mirror layer 320 may include a half mirror structure, and may also include a beam splitter.

The half mirror layer 320 may receive the second light 3000, and may output first lens internal light 3220. The first lens internal light 3220 and the second light 3000 may have the same phase. For example, the first lens internal light 3220 may be right-circularly polarized light or left-circularly polarized light, similarly to the second light 3000.

The lens QWP 340 may be located between the half mirror layer 320 and the reflective polarizing layer 360. The lens QWP 340 may convert the applied circularly polarized light into linearly polarized light. The lens QWP 340 may include various materials. For example, the lens QWP 340 may include triacetyl cellulose (TAC) and polyvinyl alcohol (PVA). However, the disclosure is not limited thereto.

The lens QWP 340 may receive the first lens internal light 3220, and may output second lens internal light 3240. The second lens internal light 3240 may be linearly polarized light. For example, the second lens internal light 3240 may have a phase to which a phase difference of about 90 degrees is added, as compared to the first lens internal light 3220.

The reflective polarizing layer 360 may be located on one surface of the lens QWP 340. The reflective polarizing layer 360 may be configured to reflect light of a corresponding polarization state, and may transmit light of another polarization state. According to one or more embodiments, the reflective polarizing layer 360 may have various structures. For example, the reflective polarizing layer 360 may have the characteristic described above by including a polymer material, and may have a wire grid shape structure. However, the disclosure is not limited to any example.

The reflective polarizing layer 360 may receive the second lens internal light 3240, and may output third lens internal light 3420. A phase difference of the third lens internal light 3420 might not be changed, and may have a linear polarization state that is substantially identical to the second lens internal light 3240.

The third lens internal light 3420 may be applied to the lens QWP 340, may pass through the lens QWP 340, and may be provided as fourth lens internal light 3440 facing the half mirror layer 320. The fourth lens internal light 3440 may be circularly polarized light. The fourth lens internal light 3440 may have a phase to which a phase difference of about 90 degrees is added compared to the third lens internal light 3420. Here, the fourth lens internal light 3440 may have a circular polarization state in a direction that is different from a circular polarization direction of the second light 3000. For example, when the second light 3000 is light of right-handed circular polarization, the fourth lens internal light 3440 may be light of left-handed circular polarization, and when the second light 3000 is light of left-handed circular polarization, the fourth lens internal light 3440 may be light of right-handed circular polarization.

The fourth lens internal light 3440 may be applied to the half mirror layer 320, and at least a portion of the fourth lens internal light 3440 may be reflected by the half mirror layer 320, and may be provided as fifth lens internal light 3620. The fifth lens internal light 3620 may have the same phase as the fourth lens internal light 3440, and may have a circular polarization state in substantially the same direction as the fourth lens internal light 3440.

The fifth lens internal light 3620 may be applied to the lens QWP 340, may pass through the lens QWP 340, and may be provided as sixth lens internal light 3640 facing the reflective polarizing layer 360. The sixth lens internal light 3640 may be linearly polarized light. The sixth lens internal light 3640 may have a phase to which a phase difference of about 90 degrees is added compared to the fifth lens internal light 3620.

The sixth lens internal light 3640 may be applied to the reflective polarizing layer 360, may pass through the reflective polarizing layer 360, and may be provided as the third light 4000 output to an outside. The third light 4000 may have the same phase as the sixth lens internal light 3640, and may have substantially the same linear polarization state. According to one or more embodiments, a phase difference of about 270 degrees may be added to the second light 3000 in a process of light moving through layers included in the pancake lens part 300, and the second light 3000 may pass through the reflective polarizing layer 360, and may be output as the third light 4000.

According to one or more embodiments, the third light 4000 provided to the user 2 may be provided to have a corresponding polarization state. According to one or more embodiments, the optical system 1 may have a structure that polarizes light using the pancake lens part 300 as described above, a structure of the display device 10 using the optical system 1 may be simplified, and an intended optical characteristic of provided light may be closely or precisely provided.

According to one or more embodiments, the third light 4000 output from the pancake lens part 300 may be provided toward the pupil 3 of the user 2.

The pancake lens part 300 may change (for example, refract) the light path of the applied second light 3000 so that the third light 4000 is applied to the pupil 3 of the user 2, and may output the third light 4000. For example, based on the second light 3000, the third light 4000, of which a light path is changed, may form a second angle ANG2 with respect to the base line BS.

According to one or more embodiments, the second angle ANG2 may be different from the first angle ANG1. However, the disclosure is not limited thereto, and according to one or more embodiments, the second angle ANG2 may be similar to the first angle ANG1.

The third light 4000 may be applied to the pupil 3 of the user 2 to be inclined with respect to the first light 2000 output by the display part 100. For example, at least a portion of the third light 4000 may be provided from an area adjacent to the edge portion EDG of the pancake lens part 300, and may be applied to the pupil 3 of the user 2 located in a relatively narrow area compared to the pancake lens part 300.

The light path of the first light 2000 may be changed by the light path converter 200, the second light 3000 may be applied to the pancake lens part 300 over a relatively wide area, and the third light 4000, which is based on the second light 3000, may be provided to the user 2.

According to one or more embodiments, the display part 100 may output light information along a vertical direction (for example, a direction parallel to the display direction DR_D), and light information, of which a light path is changed by the light path converter 200 and by the pancake lens part 300, may be provided to the user 2. That is, the second angle ANG2 of the third light 4000, which is applied to the user 2, may be distributed between a relatively low angle (for example, about 0 degrees) and a relatively large angle (for example, about 70 degrees or the like).

Experimentally, for the user 2 to clearly recognize a formed optical image formed by the optical system 1, a distribution (for example, an intensity) of the third light 4000 applied according to each size of the second angle ANG2 may be suitably substantially uniformly formed. For example, when the intensity of the third light 4000 at a high second angle ANG2 is relatively significantly lower than the intensity of the third light 4000 at a low second angle ANG2, it may be difficult for the user 2 to clearly recognize the optical image intended by the optical system 1.

However, according to one or more embodiments, the light path converter 200, which changes a light path to be adjacent to the edge portion EDG of the pancake lens part 300, may be located between the pancake lens part 300 and the display part 100, and the above-described effect may be reduced or prevented, and an optical system 1 capable of providing excellent color brightness and color uniformity may be provided.

In addition, because at least a portion of a light path in the optical system 1 is changed by the light path converter 200 using the geometric phase lens or the Pancharatnam-Berry phase plate, a risk that optical information or optical characteristics of light provided by the display part 100 (for example, brightness, uniformity, and the like) is changed may be reduced.

In addition, as the above-described structure is implemented, the display part 100 may include a light-emitting structure based on a front light-emitting structure, and thus, because excessive additional structures are not required, power efficiency may be improved, power consumption may be reduced, a light emission amount in a vertical direction of the light-emitting element LD may be increased, and a lifespan of the light-emitting element LD may be increased.

According to one or more embodiments, the optical system 1 may be applied to display structures of various fields. For example, the display device 10 may be configured to implement a virtual reality system, an augmented reality system, a mixed reality system, or one of a combination thereof using the optical system 1.

For example, the display device 10 may be a (head mounted display) HMD. The HMD may be a wearable electronic device that may be worn on a head of the user 2. For example, the display device 10 may include a head mounted member 12 and a display storage member 14.

Hereinafter, an electronic device 1000 including the display device 10 in accordance with one or more embodiments will be described.

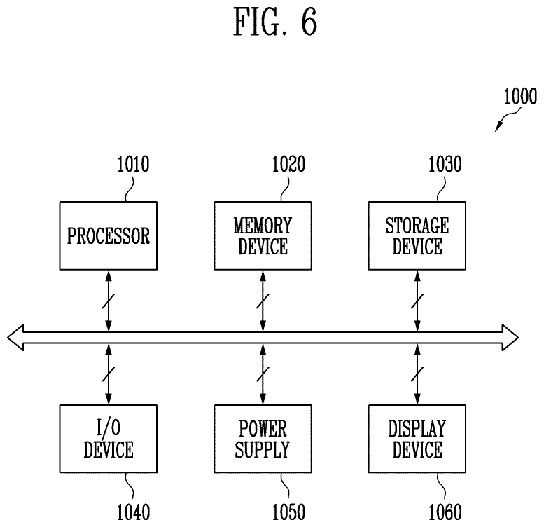

FIG. 6 is a schematic block diagram illustrating an electronic device 1000 including a display device in accordance with one or more embodiments.

Referring to FIG. 6, the electronic device 1000 may include a processor 1010, a memory device 1020, a storage device 1030, an input/output (I/O) device 1040, a power supply 1050, and a display device 1060. The display device 1060 may be the display device component including the optical system 1. The electronic device 1000 may further include various ports for communication with a video card, a sound card, a memory card, a USB device, or other systems.

In accordance with the embodiments, the electronic device 1000 may be a head-mounted display (HMD), as described above, with reference to FIG. 5. However, this disclosure is not limited thereto. For example, the electronic device 1000 may be applied to smart glasses or various electronic devices for extended reality.

Alternatively, in another example, the electronic device 1000 may be a smartphone or a tablet PC.

However, the aforementioned examples are illustrative, and the electronic device 1000 is not limited to the aforementioned examples. For example, the electronic device 1000 may be implemented as a cellular phone, a video phone, a smartpad, a smartwatch, a navigation device for vehicles, a computer monitor, a laptop computer, or the like.

The processor 1010 may perform corresponding calculations or tasks. In one or more embodiments, the processor 1010 may be a micro-processor, a central processing unit, an application processor, or the like. The processor 1010 may be connected to other components through an address bus, a control bus, a data bus, and the like. In one or more embodiments, the processor 1010 may be connected to an expansion bus, such as a peripheral component interconnect (PCI) bus. In one or more embodiments, the processor 1010 may provide input image data to the display device 1060. Hence, the display device 1060 may display an image based on the input image data provided from the processor 1010.

The memory device 1020 may store data needed to perform the operation of the electronic device 1000. For example, the memory device 1020 may include non-volatile memory devices, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, and a ferroelectric random access memory (FRAM) device, and/or volatile memory devices, such as a dynamic random access memory (DRAM) device, a static random access memory (SRAM) device, a mobile DRAM device, and so on.

The storage device 1030 may include a solid state drive (SSD), a hard disk drive (HDD), a CD-ROM, or the like.

The I/O device 1040 may include input devices, such as a keyboard, a keypad, a touchpad, a touch screen, and a mouse, and output devices, such as a speaker and a printer. In one or more embodiments, the display device 1060 may be included in the I/O device 1040.

The power supply 1050 may supply power needed to perform the operation of the electronic device 1000. For example, the power supply 1050 may be a power management integrated circuit (PMIC). In one or more embodiments, the power supply 1050 may supply power to the display device 1060.

The display device 1060 may display an image corresponding to visual information of the electronic device 1000. The display device 1060 may be connected to other components through the buses or other communication links.

As described above, although the disclosure has been described with reference to the preferred embodiment above, those skilled in the art or those having a common knowledge in the art will understand that the disclosure may be variously modified and changed without departing from the spirit and technical area of the disclosure described in the claims.

Therefore, the technical scope of the disclosure should not be limited to the contents described in the detailed description of the specification, but should be defined by the claims, with functional equivalents thereof to be included therein.

What is claimed is:

1. An optical system comprising:
a display part comprising a display layer comprising a light-emitting element, a first quarter wave plate (QWP) on the display layer, an absorbing polarizing layer on the first QWP, and a second QWP on the absorbing polarizing layer;
a light path converter on the display part; and
a pancake lens part on the light path converter,
wherein the display part is configured to output first light provided to the light path converter, and
wherein the light path converter is configured to receive the first light and is configured to output second light of which a light path is converted based on the first light.

2. The optical system of claim 1, wherein the first light comprises circularly polarized light formed by transmitting linearly polarized light from the display layer through the first QWP, the absorbing polarizing layer, and the second QWP, and
wherein the pancake lens part is configured to receive the second light, and is configured to output third light of which a light path is converted based on the second light.

3. The optical system of claim 1, wherein the first light is configured to be applied to the light path converter along a display direction, and
wherein the display direction is substantially perpendicular to a display surface of the display layer.

4. The optical system of claim 3, wherein the first light is configured to be applied to the light path converter along a direction substantially parallel to a base line, and
wherein the second light is configured to be applied to the pancake lens part along a direction forming a first angle with respect to the base line.

5. The optical system of claim 4, wherein the base line is a virtual line extending along the display direction.

6. The optical system of claim 4, wherein the light path converter is configured to shift a light path of the first light in a direction from a center portion of the pancake lens part toward an edge portion of the pancake lens part.

7. The optical system of claim 6, wherein the display part is configured to provide the first light to a first range, and
wherein the pancake lens part is configured to receive the second light in a second range that is wider than the first range.

8. The optical system of claim 1, wherein the light path converter comprises an anisotropic structure.

9. The optical system of claim 8, wherein the light path converter has a flat plate shape.

10. The optical system of claim 8, wherein the light path converter comprises at least one of a geometric phase lens or a Paancharatnam-Berry phase plate.

11. The optical system of claim 10, wherein the light path converter comprises a concave lens having a negative focal length.

12. The optical system of claim 11, wherein the light path converter is configured to provide the first light circularly polarized in a direction different from a direction in which the first light is circularly polarized.

13. The optical system of claim 1, wherein the light path converter is on the display part, and is spaced apart from the pancake lens part.

14. The optical system of claim 1, wherein the pancake lens part comprises a half mirror layer on the light path converter, a lens QWP on the half mirror layer, and a reflective polarizing layer on the lens QWP, and is configured to receive the second light, and to output a third light based on the second light.

15. The optical system of claim 14, wherein the pancake lens part comprises a body lens part having a convex lens shape, and
wherein the third light is linearly polarized light, and is configured to be applied to a user's pupil.

16. The optical system of claim 1, wherein the light-emitting element comprises an organic light-emitting element (OLED) or an inorganic light-emitting element.

17. A display device comprising an optical system comprising:
a display part comprising a display layer comprising a light-emitting element, a first quarter wave plate (QWP) on the display layer, an absorbing polarizing layer on the first QWP, and a second QWP on the absorbing polarizing layer;
a light path converter on the display part; and
a pancake lens part on the light path converter,
wherein the display part is configured to output first light provided to the light path converter, and
wherein the light path converter is configured to receive the first light and is configured to output second light of which a light path is converted based on the first light.

18. The display device of claim 17, wherein the display device comprises one of a virtual reality system, an augmented reality system, a mixed reality system, or a combination thereof.

19. An electronic device, comprising:
a processor configured to provide input image data;
a display device configured to display an image based on the input image data, the display device comprising sub-pixel areas; and
a power supply configured to supply power to the display device,
wherein the display device comprises an optical system comprising:
a display part comprising a display layer comprising a light-emitting element, a first quarter wave plate (QWP) on the display layer, an absorbing polarizing layer on the first QWP, and a second QWP on the absorbing polarizing layer;
a light path converter on the display part; and
a pancake lens part on the light path converter,
wherein the display part is configured to output first light provided to the light path converter, and
wherein the light path converter is configured to receive the first light and is configured to output second light of which a light path is converted based on the first light.
